(19) United States
(12) Patent Application Publication
(10) Pub. No.: US 2011/0120323 A1
(43) Pub. Date: May 26, 2011

(54) VERTICAL PRESS FOR GRAPES AND OTHER FRUIT

(75) Inventors: Matteo COMANDINI, Cesena (Forli Cesena) (IT); Massimo MELANDRI, Lugo (Ravenna) (IT)

(73) Assignee: DIEMME S.P.A., Lugo (Ravenna) (IT)

(21) Appl. No.: 12/950,333

(22) Filed: Nov. 19, 2010

(30) Foreign Application Priority Data
Nov. 25, 2009 (EP) 09425483.6

(51) Int. Cl. B30B 9/02

(52) U.S. Cl. 100/131

(57) ABSTRACT

A press is provided including a perforated draining drum; a juice collecting vat on a bottom of which the perforated drum is rested; a mobile member, located above the drum and activated with a vertical movement by powering device; a presser plate, which descends in the drum, to press the load; raising mechanism for raising the drum to extract the pressed product residue. The press also includes: a stem, carried by the mobile member, having a lower end to which the plate is fixed and having a variable length between a maximum and a minimum length which is reached following descent of the mobile member and an elastic member acting on the stem to increase its length, thereby displacing the residue of pressed product out of the drum. The residue is evacuated automatically by simple bodies which do not require operating liquids which might undesirably fall into the collecting vat.

### FIELD OF INVENTION

The invention relates to a vertical press for grapes and other fruits, of a type comprising a perforated draining drum, open at the top and bottom bases, and a collecting vat for the juice on the bottom on which the perforated drum is rested, the drum and the vat defining a pressing chamber into which a load of product to be pressed is placed; a horizontal presser plate, destined to descend into the perforated drum, above the load, in order to press the load, is carried by a mobile crossbar located superiorly of the draining drum, activated vertically by vertical-axis hydraulic actuators.

### BACKGROUND

In use, the presser plate is translated downwards by the mobile member up to reaching, at a minimum distance from the bottom of the vat, a maximum compression level. At this level, the product has been completely pressed and reduced to a mass of residual product (stems, skins, leaves and woody residues). In the subsequent stage, the residual product is expelled from the drum; to this end, the drum is raised, for example by the hydraulic actuators, and at the same time the presser plate is pushed downwards by a further hydraulic actuator which keeps the residues pressed against the bottom of the collection vat while the drum is raised up to producing complete exit of the residues from the drum.

The described type of press exhibits drawbacks due to the fact that the actuator means which activates the presser plate, because of its relatively complex and hydraulic conformation, can easily be affected by operating oil leakage, or leakage of similar substances, with the risk that these might pollute and damage the product and even render it non-utilisable.

### SUMMARY

The present disclosure is directed to a vertical press for pressing grapes and other fruits. The press includes a perforated draining drum, open at a lower base thereof, a residual load after pressing is extractable therefrom. The press also includes a juice collecting vat on a bottom of which the perforated drum is rested, the drum and the vat delimiting a pressing chamber destined to receive a load of product to be pressed. Also included is a mobile member, located superiorly of the draining drum and activated with a vertical movement by a powering device between an upper position and a lower position at a minimum distance from the bottom of the vat. The press further includes a horizontal presser plate destined to descend internally of the perforated drum above the load, in order to press the load. The presser plate is pushed downwards by the mobile member. A raising mechanism is also included, which raises the perforated drum, with respect to the vat, for extraction therefrom of the residue of the pressed product, which includes connecting elements for connecting the drum to the mobile member. A stem, carried by the mobile member, projects downwards and has a lower end to which the presser plate is fixed, the stem has a variable length between a maximum length and a minimum length which is reached following the descent of the mobile member on the load. An elastic member acts on the stem to increase a length of the stem, and is able to provide such a thrust as to displace the residue of pressed product out of the perforated drum.

### BRIEF DESCRIPTION OF THE DRAWINGS

The invention is described in detail in the following with the help of the accompanying figures, which illustrate a preferred embodiment thereof purely by way of non-limiting example.

FIG. 1 is a partly-sectioned vertical elevation of the press of the invention.

FIGS. 2A and 2B illustrate a same detail of FIG. 1 in an enlarged view and in two different configurations.

FIGS. 3A, 3B and 3C show the press of FIG. 1 in three successive stages of the compression of the load of product.

FIGS. 3D and 3E show the press of FIG. 1 in two successive stages of the expulsion of the residue from the drum.

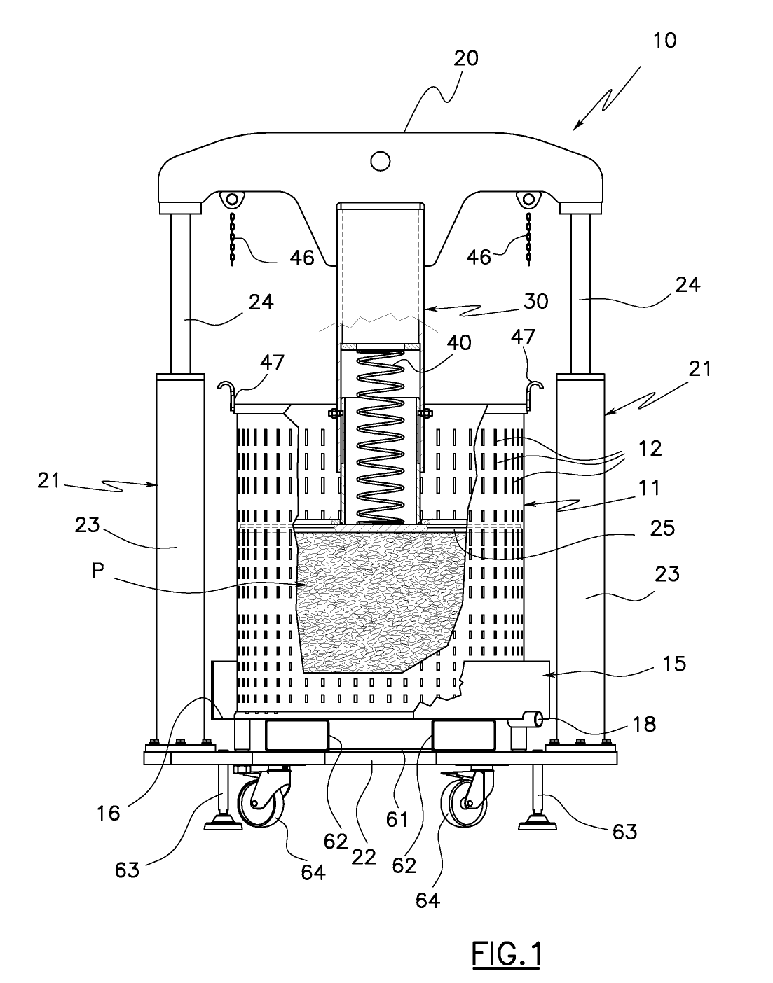

### DETAILED DESCRIPTION OF THE PREFERRED EMBODIMENTS

### Introduction to the Embodiments

An aim of the present invention is to obviate the described drawback and at the same time make the structure of the press simpler and more economical.

This and other aims are attained by the features of the appended claims.

### DETAILED DESCRIPTION

The press of the invention (denoted in its entirety by 10 in the figures) comprises a perforated draining drum 11, open at the upper and lower bases thereof, a residual load from pressing being extractable vertically from the perforated drum 11. The drum 11 is preferably essentially formed by a cylindrical lateral wall having a circular section and perforated by openings 12 distributed over a whole surface thereof, and able to retain the product and enable draining of the juice from the material (grapes or other fruits) during pressing.

A juice collecting vat 15 is located in the lower part of the press, the lower edge 11a of the perforated drum 11 resting on the bottom 16 thereof. The drum 11 and the vat 15 delimit a pressing chamber destined to receive a load of product to be pressed.

The vat 15 preferably has a greater diameter than the drum 11 and a base (not illustrated in the figures) is preferably located on the bottom 16 of the vat 15. The base is preferably shaped such as to facilitate draining and evacuation of the juice produced by the pressing. At least an outlet 18 connected to the bottom of the vat 15 is included.

In the embodiment illustrated in the figures, the vat 15 is fixed above a metal support base 61, conformed as a pallet, i.e. having two through-channels 62 destined to receive the tines of a usual fork-lift truck.

The press further comprises a mobile member 20 located in a position above the pressing drum 11, activated with a vertical movement by powering means between an upper position and a lower position of minimum distance from the bottom of the vat.

In a preferred embodiment the member 20 is a sturdy horizontal arm, the ends of which are connected to two large vertical hydraulic linear actuators 21 (powering means) which provide the energy necessary for pressing. The two actuators 21 are supported and constrained at lower ends thereof to a base plate 22 which also functions as a rest base for the collecting vat 15.

In detail, each actuator 21 comprises an operating cylinder 23, the base cylinder of which is fixed to the base plate 22 from which a vertical stem 24 projects in an upwards direction. A corresponding end of the mobile member 20 is connected to the upper end of the vertical stem 24.

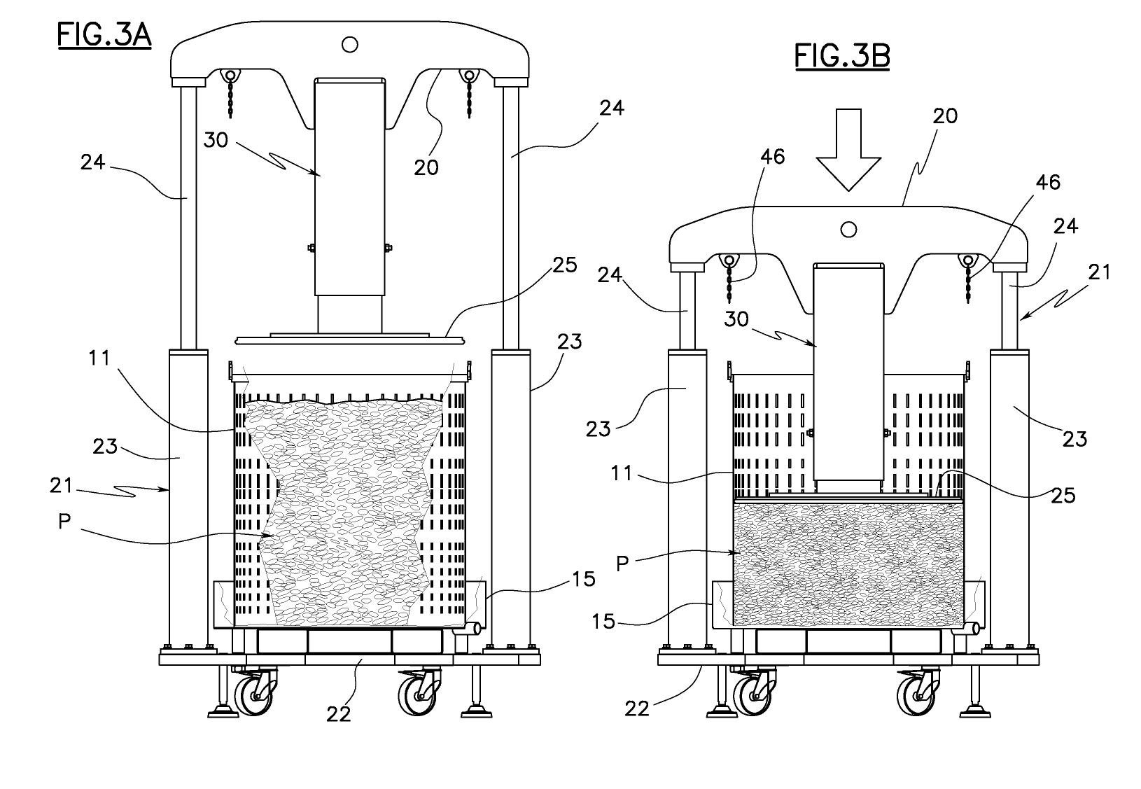

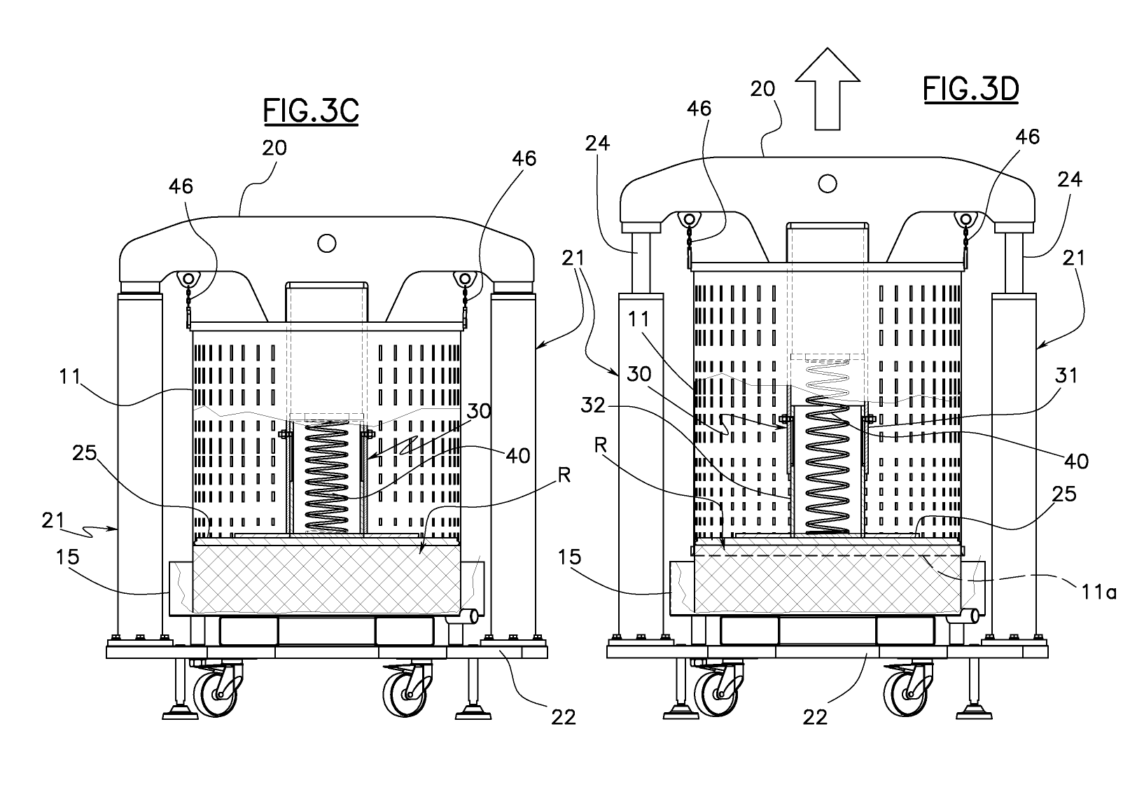

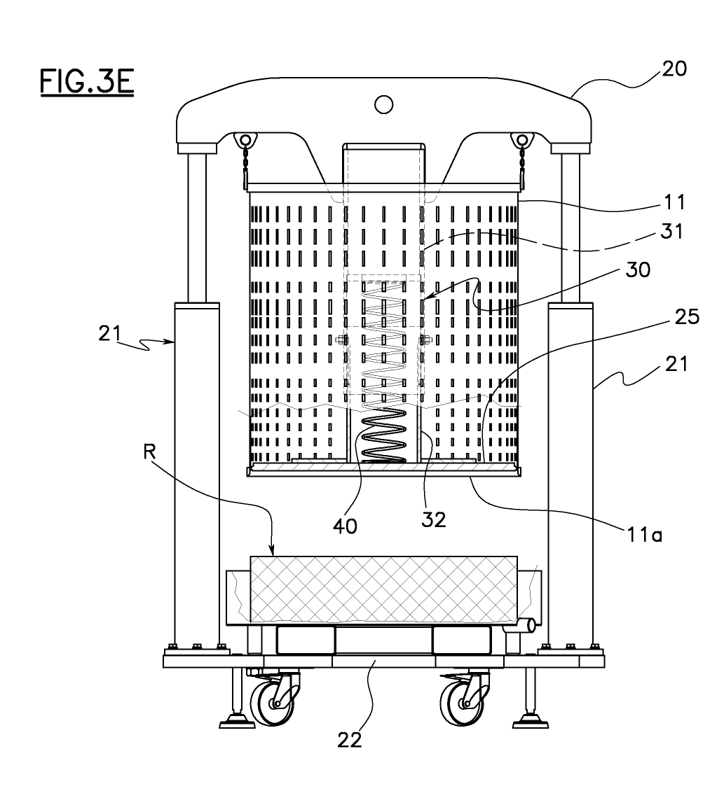

The mobile member 20, two actuators 21 and the base plate 22 define a portal frame, an upper crossbar of which (defined by the member 20) is mobile and internally of which is located the product compression chamber (drum 11 and vat 15). The mobile member 20 is actuated with a vertical movement between an upper position (which reaches a maximum level in FIG. 3A) and an extreme lower position of minimum distance from the bottom of the vat 15 (FIG. 3C), with a maximum retraction of the stems 24.

The base plate 22 defines the base of the press 10 and can be provided with removable rest feet 63 and wheels 64 for moving the press.

The press 10 further comprises a horizontal presser plate 25 carried by the mobile member 20 and destined to descend internally of the perforated drum 11 above the load of product to be pressed P, located internally of the drum 11 in order to press the load P, the presser plate 25 being pushed downwards by the mobile member 20 up to reaching the minimum operating distance from the bottom of the vat 15 (FIG. 3C).

The invention comprises a vertical stem 30 carried by the mobile member 20 and projecting downwards, at a lower end 32a of which the presser plate 25 is fixed, the stem 30 having a length which is variable between a maximum value and a minimum value reached during the descent of the mobile member 20 on the load. An elastic member 40 is associated to the stem 30, which elastic member 40 is normally destined to extend its length and which is capable of providing a thrust which can displace the residue of product pressed out of the perforated drum.

In a preferred embodiment of the invention, the stem 30 is telescopic and comprises two tubular segments 31 and 32 partially inserted one in another, and having the capability of varying the total length of the stem 30.

In particular, the external segment 31 is located superiorly of the other and the upper end thereof is solidly fixed to the mobile member 20. The internal segment 32 faces downwards and the presser plate 25 is fixed to the lower end 32a thereof.

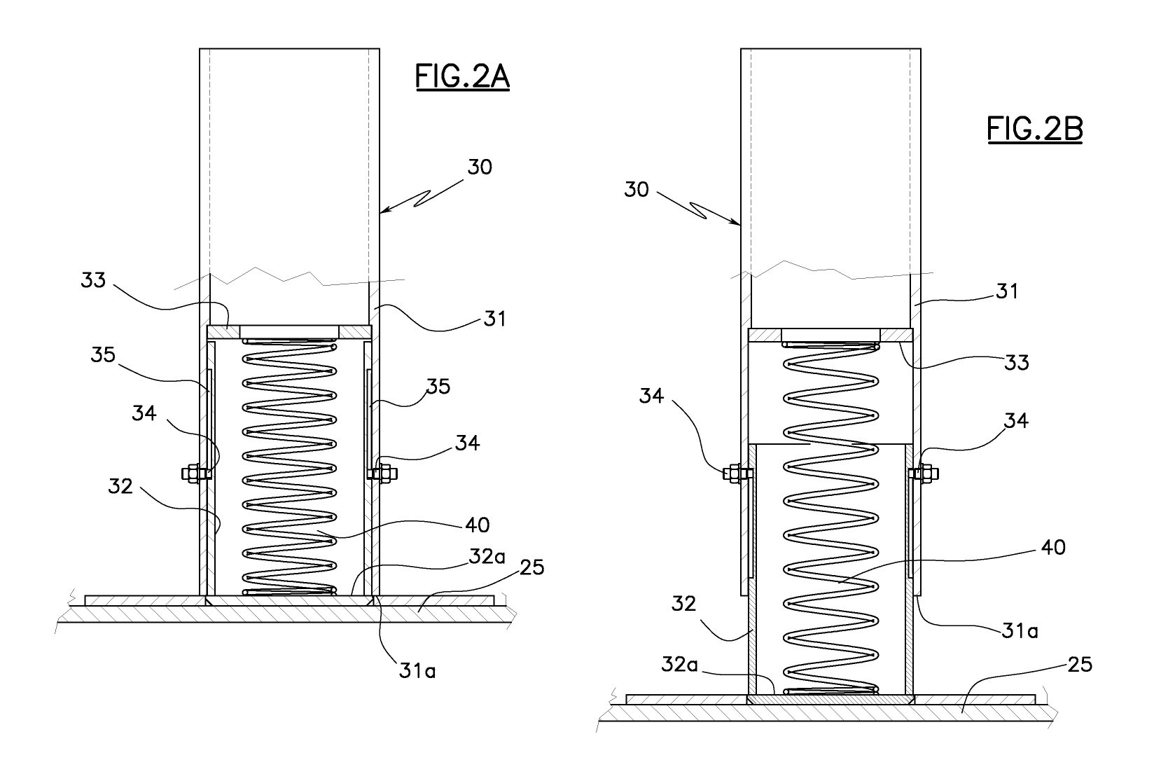

The sliding of the internal segment 32 with respect to the segment 31 and thus the length of the stem 30 is limited on one side by a stop constituted by the lower edge 31a of the external segment 31, which strikes against the upper surface of the plate 25 and stops the re-entrance of the internal segment 32, defining the minimum length of the stem 30 (as illustrated in FIG. 2A).

The extending sliding of the internal segment 32 with respect to the segment 31 is limited by two stops 34; for example, these stops 34 are defined by threaded pins, located in through-holes afforded close to the lower end of the external segment 31 and slidable in axial channels 35 afforded on the external surface of the internal segment 32; when the segment 32 is in the completely extracted position (as illustrated in FIG. 2B), the two pins 34 come into contact with the upper end of the channels 35, blocking the exit of the internal segment 32.

The elastic member 40 is located internally of the stem 30, and in particular is constituted by a helical spring located internally of the two segments 31 and 32, compressed between an annular stop 33 fixed to the internal surface of the external segment 31 and the final end 32a of the internal segment 32, which spring reaches the maximum compression thereof during the final stage of the load pressing.

The press 10 further comprises raising mechanism for raising the perforated drum with respect to collecting vat 15, for extraction of the residue of the pressed product from the drum.

The raising mechanism comprises the mobile member 20 and the relative powering device 21 and further comprise connecting elements (preferably disconnectable) for constraining the drum 11 to the mobile member 20, so that the raising movement of member 20 could produce the raising of the drum also. In particular, said connecting elements comprise draft elements such as cables or chains 46 (or other equivalents) lower ends of which are hooked to hooks 47 fixed at the upper end of the perforated drum (possibly automatically).

In use, a load P is initially arranged internally of the drum 11, which is placed below the presser plate 25 and resting on the bottom of the collecting vat 15, in turn located on the base 22 of the press (as illustrated in FIG. 3A). This configuration can be actuated by first loading, at a distance from the press, a load P internally of the drum 11, located resting on the bottom of the collecting vat 15 and thus transferring, for example by a fork-lift truck, the vat 15-drum 11 group together with the load P resting on the base 22, into a centred position below the presser plate 25. Then the load P is compacted by the controlled descent of the mobile member 20 which, in turn, produces the descent of the presser plate 25 above the load P, such as to compact the load internally of the drum 11 in order to near the presser plate 25 to the base of the vat 15.

In the first part of the descent (FIG. 3B), the stem 30 reduces the length thereof as the resistance the plate 25 encounters from the load P exceeds the thrust provided by the spring 40; this length is reduced up to a minimum amount, in which the internal segment 32 is retracted to a maximum internally of the external segment 31 (and the spring 40 is compressed to the maximum degree) (FIG. 2A). From that moment onwards, during the further compacting stage, the stem 30 behaves as a single rigid member.

The compacting of the load terminates when the mobile member 20 reaches the lower position of minimum distance from the bottom of the vat 15. The presser plate 25 likewise reaches the minimum distance from the bottom of the vat (FIG. 3C).

In this configuration, the load, substantially freed of its juice, has been reduced to a pressed residue R, having a smaller volume and a greater hardness with respect to the initial load P.

The pressed residue R is then extracted from the draining drum 11 in order for the residue to be transferred and the vat 15 and the drum 11 to be refilled with another load.

To this end first the drum 11 is connected to the mobile member 20 by hooking the chains 46 to the hooks 47, and then the actuators 21 are activated to raise the member 20 and therefore the drum 11.

During this stage, while the drum is raised upwards, the action of the spring 40, which is fully compressed, pushes the plate 25 downwards, and thanks to the thrust keeps the residue R in contact against the bottom of the vat 15. In the first part of the raising of the drum 11, while the member 20 moves upwards, the stem 30 lengthens and thus the thrust of the spring 40 reduces in intensity; the action of the spring 40 is sufficient to push the residue R completely out of the drum 11, or at least is sufficient for the residue R to remain resting internally of the vat 15 (FIG. 3D).

At this point the spring 40 has completed its work and the drum 11 continues in its upward run (FIG. 3E) to enable a distancing of the vat 15 with the residue R.

Thanks to the invention, the evacuation of the residue is done automatically by simple bodies, which do not require the use of operating liquids or other substances which might undesirably fall internally of the collection chamber.

Obviously numerous modifications of a practical-applicational nature can be brought to the invention without its forsaking the ambit of the inventive idea as claimed herein below.

What is claimed is:

1). A vertical press for pressing grapes and other fruits, comprising:
a perforated draining drum (11), open at a lower base thereof, a residual load (R) after pressing being extractable therefrom;
a juice collecting vat (15) on a bottom of which the perforated drum (11) is rested, the drum (11) and the vat (15) delimiting a pressing chamber destined to receive a load of product (P) to be pressed;
a mobile member (20), located superiorly of the draining drum (11) and activated with a vertical movement by a powering device (21) between an upper position and a lower position at a minimum distance from the bottom of the vat (15);
a horizontal presser plate (25) configured to descend internally of the perforated drum (11) above the load (P), in order to press the load (P), the presser plate (25) being pushed downwards by the mobile member (20);
raising mechanism configured to raise the perforated drum (11), with respect to the vat (15), for extraction therefrom of the residue (R) of the pressed product, which comprises connecting elements (46, 47) for connecting the drum (11) to the mobile member (20);
a stem (30), carried by the mobile member (20), projecting downwards and having a lower end to which the presser plate (25) is fixed, the stem (30) having a variable length between a maximum length and a minimum length which is reached following the descent of the mobile member (20) on the load (P); and
an elastic member (40) acting on the stem (30) to increase a length of the stem (30), and able to provide such a thrust as to displace the residue (R) of pressed product out of the perforated drum (11).

2). The press of claim 1, wherein the stem (30) is telescopic and comprises two tubular segments (31, 32) partially inserted one in another, to allow a varying of a total length of the stem (30), and a helical spring (40) located internally of the two segments (31, 32), said helical spring (40) reaches a maximum compression thereof during a final stage of pressing of the load (P).

3). The press of claim 1, wherein the connecting elements (46, 47) comprise cables or chains for connecting the drum (11) to the mobile member (20).

4). The press of claim 3, wherein the cables or chains (46) comprise lower ends, which are hooked to hooks (47) fastened to the perforated drum (11).
